(19) United States
(12) Patent Application Publication
(10) Pub. No.: US 2002/0082955 A1
(43) Pub. Date: Jun. 27, 2002

(54) Computer-based education system for scientific procedures with product procurement capability

(76) Inventors: Salil D. Patel, Cupertino, CA (US); Sunil Maulik, Santa Clara, CA (US); Jerry Brosnan, San Francisco, CA (US)

Correspondence Address: KOLISCH HARTWELL DICKINSON MCCORMACK &, HEUSER, 520 S.W. YAMHILL STREET, SUITE 200, PORTLAND, OR, 97204, US

(21) Appl. No.: 09/981,647

(22) Filed: Oct. 15, 2001

Related U.S. Application Data
(60) Provisional application No. 60/240,537, filed on Oct. 13, 2000.
(60) Provisional application No. 60/199,607, filed on Apr. 25, 2000.
(60) Provisional application No. 60/233,509, filed on Sep. 19, 2000.

(51) Int. Cl. G06F 17/60

(52) U.S. Cl. 705/28

(57) ABSTRACT

A computer-implemented education and procurement system, method, and program storage medium for use in learning about scientific procedures and procuring products related thereto. According to one aspect of the invention, the system may include a graphical user interface (GUI) configured to display (a) a user-selected tutorial having a description of a scientific procedure, (b) one or more requirements for the scientific procedure, and (c) product information regarding one or more commercially available products that may be used to satisfy each requirement. According to another aspect of the invention, the method may include, receiving a command from a user to display a user-selected tutorial containing information related to a scientific procedure, displaying the user-selected tutorial, and on the same screen as the tutorial, displaying product information corresponding to one or more commercially available products required to conduct the scientific procedure.

### CROSS REFERENCE TO RELATED APPLICATION

This application is based upon and claims priority under 35 U.S.C. §119(e) to U.S. Provisional Patent Application No. 60/240,537, filed Oct. 13, 2001, entitled “Electronic Procurement System,” which is herein incorporated by reference in its entirety for all purposes. This application also incorporates by reference the following U.S. Pat. applications in their entirety for all purposes: U.S. patent application Ser. No. 09/843,163, filed Apr. 25, 2001, entitled “Computer-Based Educational System,” and the provisional applications upon which it is based, U.S. Provisional Pat. App. No. 60/199,607, entitled “Information Transfer System,” filed Apr. 25, 2000, and U.S. Provisional Pat. App. No. 60/233,509, entitled “Information Transfer System,” filed Sep. 19, 2000.

### FIELD OF THE INVENTION

The invention relates generally to education and procurement systems, and more particularly to a computer-based system configured to display a user-selected tutorial related to a scientific procedure, and to present information on commercially available products required to conduct the scientific procedure.

### BACKGROUND OF THE INVENTION

Goods and services may be procured by a variety of mechanisms, including direct purchase from a store and indirect purchase from a catalog or on-line vendor. Even though almost any product may now be purchased from any one type of these vendors, current procurement systems suffer from a number of shortcomings. In particular, stores, catalogs, and on-line vendors typically organize products by type rather than function or other higher-level association. Thus, a scientist ordering materials to perform the polymerase chain reaction (PCR) generally will have to review separate catalogs or catalog sections to buy the required equipment and reagents. The scientist must physically locate the many separate catalogs, determining that each is not out of date, and search for the desired products within each catalog. This consumes valuable time and energy of the scientist, which might otherwise be devoted to research. Moreover, stores, catalogs, and on-line vendors typically do not provide information on how to perform a procedure, or on the materials required to perform a procedure. Thus, a scientist wanting to perform PCR may have to study a textbook to understand the technique and then piece together a list of required materials from various sources.

### SUMMARY OF THE INVENTION

The invention provides a computer-implemented education and procurement system, method, and program storage medium for use in learning about scientific procedures and procuring products related thereto. According to one aspect of the invention, the system may include a graphical user interface (GUI) configured to display (a) a user-selected tutorial having a description of a scientific procedure, (b) one or more requirements for the scientific procedure, and (c) product information regarding one or more commercially available products that may be used to satisfy each requirement. According to another aspect of the invention, the method may include, receiving a command from a user to display a user-selected tutorial containing information related to a scientific procedure, displaying the user-selected tutorial, and on the same interface as the tutorial, displaying product information corresponding to one or more commercially available products required to conduct the scientific procedure.

### BRIEF DESCRIPTION OF THE DRAWINGS

FIG. 1 is a schematic view of a computer-implemented education and procurement system in accordance with one embodiment of the invention.

FIG. 2 is a schematic view of a computing device suitable for use as an education and procurement server of the system of FIG. 1.

FIG. 3 is a schematic view of an graphical user interface (GUI) of an education and procurement program, the GUI being configured to be served by the education and procurement server and displayed by the client of FIG. 1.

FIG. 4 is a schematic view of a tutorial displayed by the GUI of FIG. 3.

FIG. 5 is a flowchart of a method according to one embodiment of presentation invention.

### DETAILED DESCRIPTION OF THE INVENTION

The invention provides a computer-implemented education and procurement system, method, and program storage medium for use in learning about scientific procedures and procuring products related thereto.

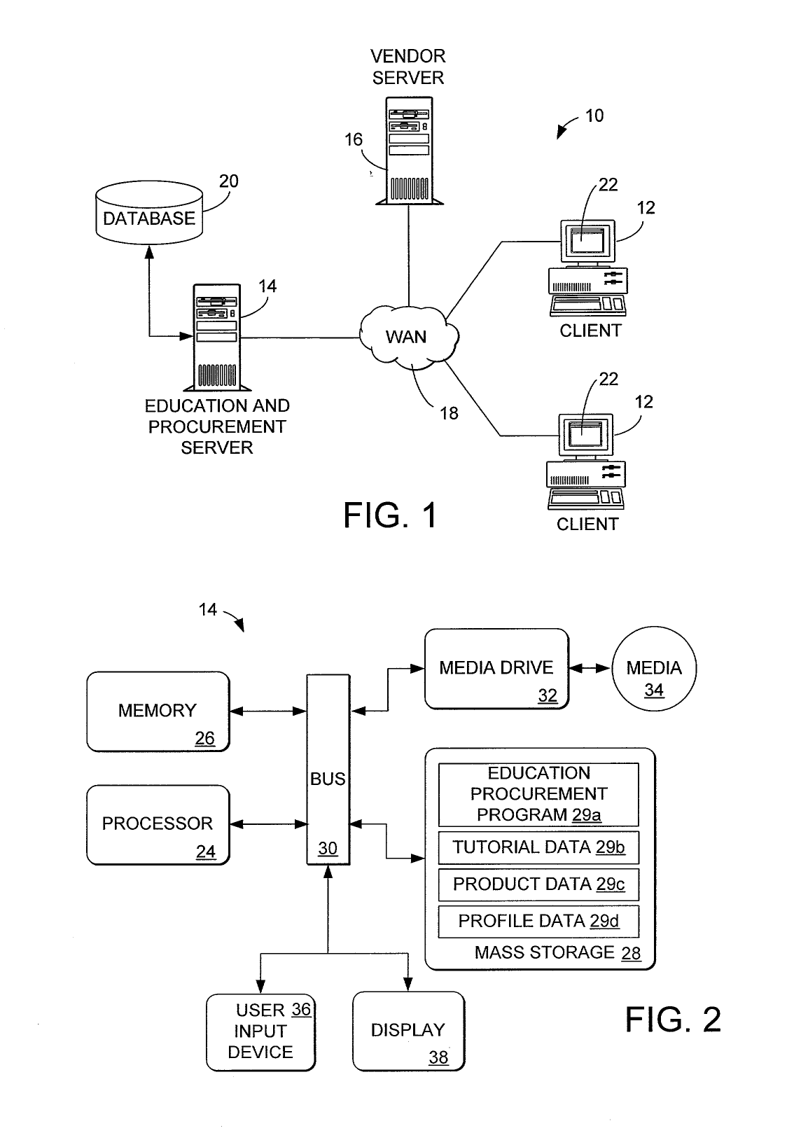

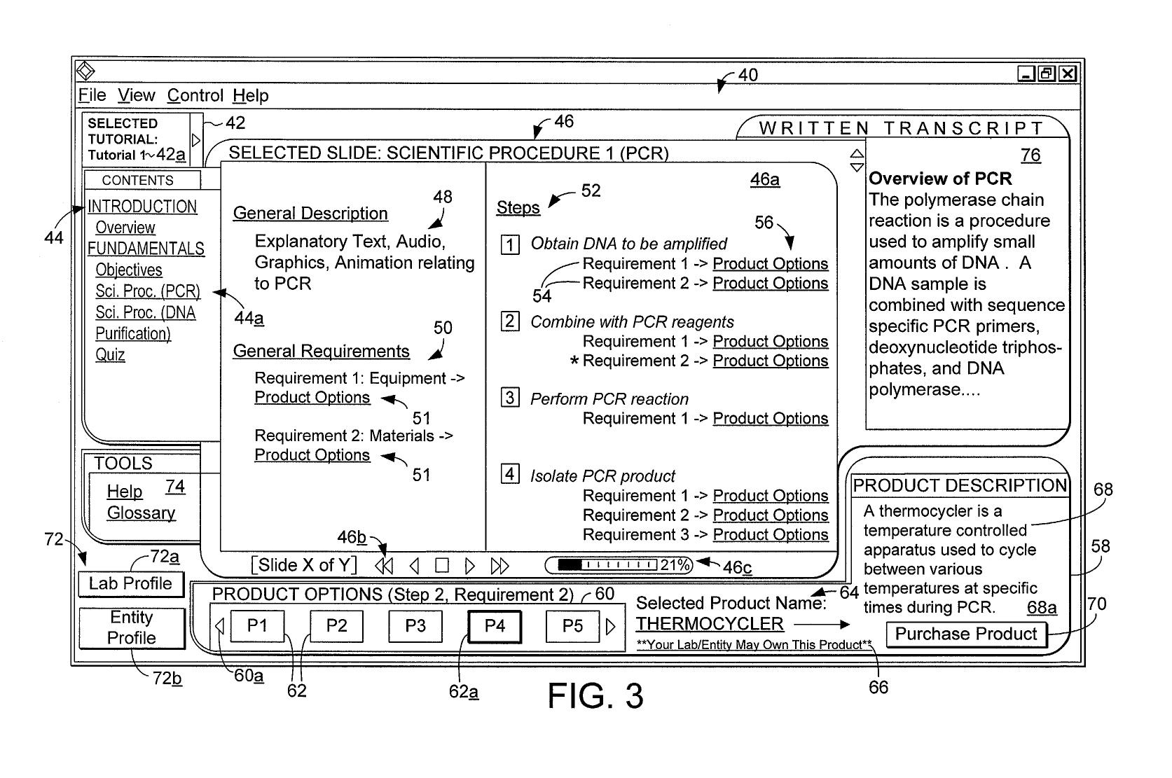

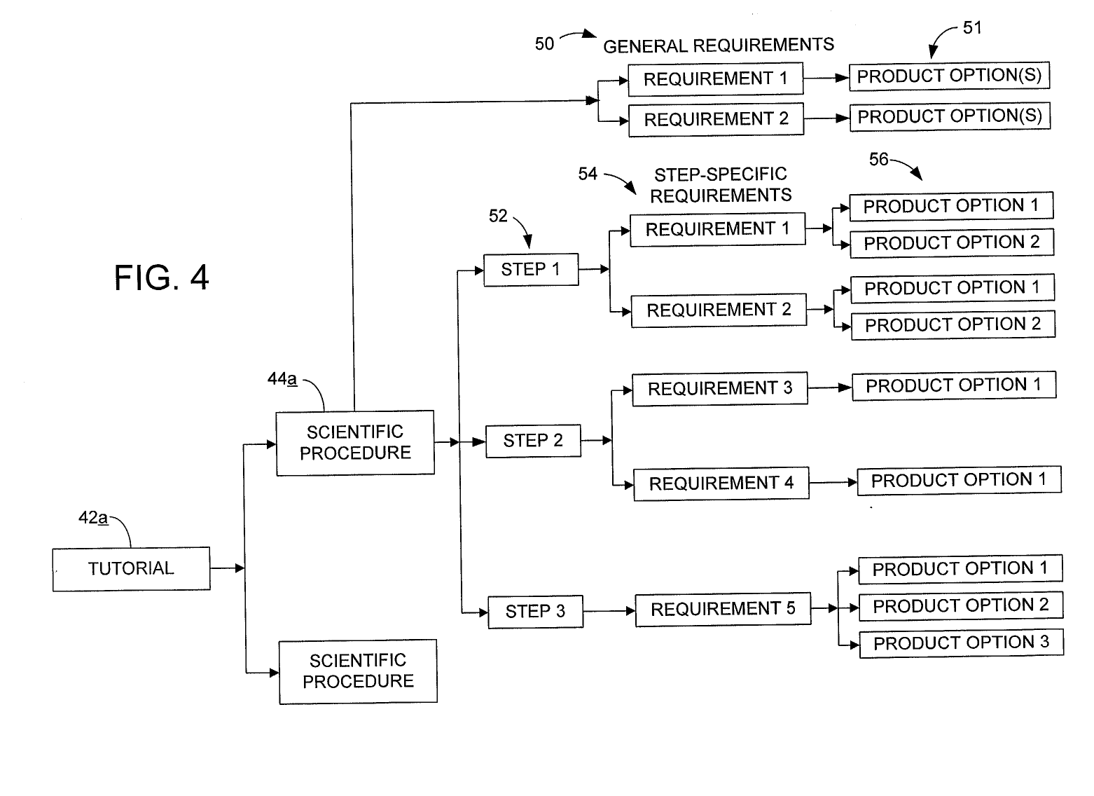

FIG. 1 shows an education and procurement system 10 according to one embodiment of the present invention. System 10 typically includes a client 12 configured to connect to an education and procurement server 14 and a vendor server 16 via computer network 18, which is typically a Wide Area Network such as the Internet. Using a web browser 22 executed on client 12, the client is configured to download and display a graphical user interface (GUI) 40, shown in FIG. 3 and described below. The GUI is configured to display a user-selected tutorial, shown at 42a in FIGS. 3-4, related to a scientific procedure, and to present information on commercially available products required to conduct the scientific procedure. The tutorial and product information is typically served to client 12 from education and procurement server 14. Alternatively, some or all of the product information may be served to client 12 from vendor server 16.

Typically, servers 14 and 16 are web servers configured to serve data to web browser 22 on clients 12 in a browser-readable form using Hypertext Transfer Protocol, and TCP/IP protocol suites. For example, the GUI, tutorial, and product data may be transmitted as static or dynamic web pages written in the Hypertext Markup Language (HTML). Alternatively, other suitable languages and protocols may be used.

The subject of the tutorial may be academic and/or commercial, for example, “drug discovery,” “molecular diagnostics,” “molecular biology,” “gene chips,” and/or “drug design,” among others, and typically includes an explanation of a scientific procedure relating thereto. The system may be used to educate a potential buyer about the attributes or advantages of a product and/or to educate an actual buyer about how to use a product. Alternatively, or in addition, the system may be used to educate a seller such as a sales person about technology associated with a product, and/or about products associated with a technology. The system may be used in almost any procurement context, including goods and services related to scientific procedures, although the preferred context is a system for the sale of goods in the life sciences and biotechnology, particularly molecular biology and genomics.

FIG. 2 illustrates an exemplary computing device suitable for use as an education and procurement server 14. It will be appreciated that client 12 and vendor server 16 also typically have a similar structure. For simplicity, the exemplary computing device of FIG. 2 will be described hereafter with reference to server 14 only.

Server 14 typically includes a processor 24 linked to a memory 26, and a mass storage device 28, via a communication bus 30. Mass storage device 28 typically is a hard drive, although any suitable mass storage device may be used. The server may also include a media drive 32 configured to read computer media 34, such as a CD-ROM, DVD-ROM, floppy disk, magneto-optical disk, etc. Using portions of memory 22, processor 24 is configured to execute education and procurement program 29a and access tutorial data 29b, product data 29c, and profile data 29d stored on mass storage device 28 in order to implement the systems and methods described herein. Alternatively, education and procurement program 29a, tutorial data 29b, product data 29c, and/or profile data 29d may be stored on media 34, database 20, or vendor server 16, and implemented by processor 24 therefrom. Computer media 34 alternatively may be referred to as a program storage medium, and data 29a, 29b, 29c, 29d may be referred to as computer program instructions encoded thereon for the purpose of causing a device such as server 14 to implement the systems and methods of the present invention.

Server 14 further may include additional components. For example, server 14 may include a user input device 36, such as a keyboard and mouse, as well as a display 38. The server 14 also typically includes speakers for presentation of audio material. Server 14 also typically includes a network interface that enables the server to communicate via computer network 16.

FIG. 3 shows one exemplary graphical user interface (GUI) 40 of education and procurement program 29a. GUI 40 is typically downloaded and displayed by web browser 22 on client 12, from server 14. Portions of GUI 40 may also be downloaded from a third party server, such as vendor server 16. In addition to the components and features described below, GUI 40 may have various additional features described in copending U.S. patent application Ser. No. 09/843,163, filed Apr. 25, 2001, entitled “Computer-Based Educational System,” and the provisional applications upon which it is based, U.S. Provisional Pat. App. No. 60/199,607, entitled “Information Transfer System,” filed Apr. 25, 2000, and U.S. Provisional Pat. App. No. 60/233,509, entitled “Information Transfer System,” filed Sep. 19, 2000, the disclosures of each of which are herein incorporated by reference in their entirety for all purposes.

GUI 40 typically includes a tutorial selector 42 configured to enable a user to select a desired tutorial for viewing. The tutorial selector is typically a pull down menu, however virtually any suitable selector configured to enable a user to select a tutorial for viewing may be used. Once the user has selected a desired tutorial 42a, table of contents selector 44 is configured to display a table of contents for the tutorial. Typically, the tutorial is in the form of a slide presentation including a plurality of audiovisual slides.

GUI 40 typically includes a tutorial presentation area 46 configured to display a slide corresponding to a user-selected entry such as user selected scientific procedure 44a. Typically, tutorial presentation area includes a tutorial presentation pane 46a, as well as slide controls 46b for selecting a current slide, and a progress indicator configured to indicate progress through a current slide. In the depicted example, a slide relating to the scientific procedure known as Polymerase Chain Reaction (PCR) has been selected, either via table of contents selector 44 or via slide controls 46b, and appears in tutorial presentation pane 46a.

As discussed above, tutorial 42a may include a wide variety of information on various topics, including a selected scientific procedure 44a. The various elements of tutorial 42a illustrated in FIG. 3 are shown in schematic form in FIG. 4. On a slide corresponding to scientific procedure 44a, tutorial presentation pane 46a is configured to display a general description 48 of the scientific procedure, as well as general requirements 50 for the procedure and links 51 to general product options related to the scientific procedure. Typically, general requirements 50 are requirements for equipment and/or consumable materials that will be used throughout the entirety of the scientific procedure. Selection of links 51 typically causes product presentation area 58 to display one or more products that will satisfy the general requirements 50.

In addition, tutorial presentation area 46 typically is configured to display one or more steps 52 for conducting selected scientific procedure 44a. For each step, tutorial presentation area 46 is configured to display one or more step-specific requirements 54. Step-specific requirements 54 typically include requirements for consumable materials and/or equipment to be used to complete a corresponding step of the scientific procedure.

Requirements 50, 54 may be virtually any type of requirement for lab equipment or consumable materials necessary to conduct selected scientific procedure 44a. Requirements 50, 54 may, for example, include virtually any requirement for an analytical, qualitative, quantitative, or other type of instrument necessary for determining a characteristic of a given sample. For example, a requirement may be for a spectrometer in order to determine the spectral characteristic's of a given sample. Required equipment also may include labware such as glassware, stir bars, hot plates and other related products necessary to perform a selected assay, experiment, or other procedure. Requirements for consumable materials may include, for example, virtually any requirement for a solvent, buffer, enzyme, cofactor, stain and/or any other reagent necessary to perform a desired assay, experiment, or other procedure. Of course, these examples should be understood to be illustrative and not limiting, as a wide variety of other equipment and consumable material requirements are possible in the life sciences, biotechnology and other sciences in general, and in molecular biology and genomics in particular.

Tutorial presentation area 46 is further configured to display a plurality of step-specific product option links 56. Selection of each link 56 typically causes product presentation area 58 to display information related to products that satisfy the associated requirement.

Product presentation area 58 typically includes a product selector 60 configured to display a plurality of products that satisfy one or more requirements 50, 54 of the selected scientific procedure 44a. Typically, the product selector is configured to display a plurality of product identifiers 62, which are typically icons depicting an image of the product. The user may scroll through the product identifiers using controls 60a, until a desired product is seen. In response to a user selecting a selected product 62a, the GUI 40 is configured to display a description 68 of the selected product in a product description area 68a, as well as the name 64 of the product. The user may choose to purchase the selected product by clicking on a purchase option selector 70. The purchase transaction itself may be carried out by education and procurement server 14, or by a third party server such as vendor server 16. The system may be configured such that the product is added to an electronic shopping cart with other products for later purchase.

GUI 40 also typically includes a profile selector 72, such as lab profile selector 72a or entity profile selector 72b, configured to enable a user to enter and edit a lab-specific profile or an entity specific profile, respectively. Typically, the entity profile is created by program 29a by amalgamating a plurality of lab specific profiles for a given entity. A lab profile typically contain such information as the current inventory of lab equipment and consumable materials for a user's lab, while the entity profile typically contains a collection of lab equipment and materials inventories for a plurality of labs within a given entity. For example, system 10 may keep several profiles for individual labs at a university, and from these automatically generate an entity profile. Thus, typically the entity profile is only editable by a user with administrative privileges, while a lab profile is typically editable by one or more lab users with user-level access privileges. Data related to these profiles is stored as profile data 29d on mass storage device 28, database 20, vendor server 16, or other suitable location. Other information may also be included in the profile, such as purchase history, product preferences, licenses for hazardous materials, address and payment information, etc.

Typically, GUI 40 is configured to present product options in product presentation area 58, based on the lab-specific and/or entity-specific profiles. According to one embodiment of the invention, the GUI is configured to select products for display based on a user profile, whether lab-specific, entity-specific, or other suitable type of user profile. Typically, the GUI is configured to select and display products that are compatible with a user's current inventory of lab equipment and/or consumable materials. Alternatively, the GUI may be configured to select and display products that are not duplicated among a user's current lab equipment and/or consumable materials, as indicated in the user's lab and/or entity profile. Finally, the GUI may be configured to select an optimal product option for a given user, based on the user's lab profile and/or entity profile.

GUI 40 also be may configured to determine whether a given product is already included within a user's lab or entity inventory, and if so, display an indicator 66 to so indicate. The GUI also may indicate to the user the location of the product. For example, if the product is determined to be possessed by the user's entity, the indicator at 66 may provide the location of the product, reading as follows: “A Thermocycler is available at Your University in Professor Smith's Lab in Building 120.” Or, if the product is determined to be in the user's lab, the indicator such by reading as follows: “Are you sure you want to purchase this product, our records indicate you already own this Thermocycler.” Of course, numerous other wordings are possible.

GUI 40 may further include a transcript presentation area 76 configured to display a transcript of a narration corresponding to a current slide presented in the tutorial presentation area 46. Transcript presentation area 76 may be configured to include a transcript presentation pane that is scrollable via scroll controls, shown at the upper left of area 76.

The GUI further may include a tool selector 74 including a help tool selector configured to launch a help tool, and a glossary tool selector configured to launch a glossary tool. According to one embodiment of the present invention the help tool and glossary tool are linked web pages containing help and glossary information. Both the help and glossary tools, as well as the transcript presentation area, and many other features that may be implemented in GUI 40 are more fully described in co-pending U.S. patent application Ser. No. 09/843,163, filed Apr. 25, 2001, entitled “Computer-Based Educational System,” and the provisional applications upon which it is based, U.S. Provisional Pat. App. No. 60/199,607, entitled “Information Transfer System,” filed Apr. 25, 2000, and U.S. Provisional Pat. App. No. 60/233,509, entitled “Information Transfer System,” filed Sep. 19, 2000, the disclosures of each of which are incorporated by reference in their entirety for all purposes.

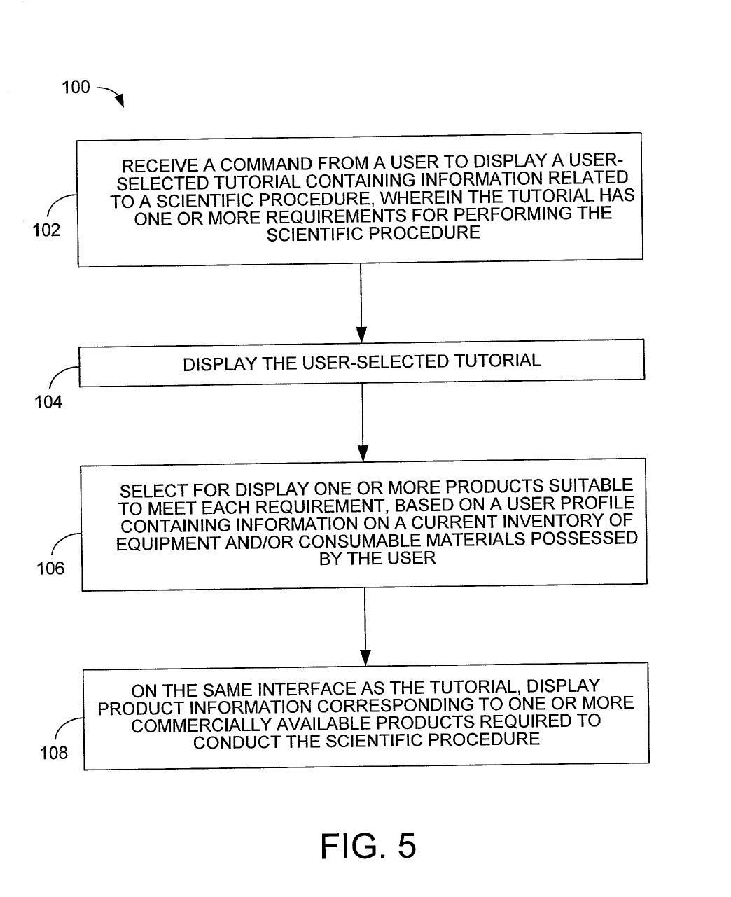

System 10 described above may be used to implement a method according to the present invention, shown at 100 in FIG. 5. Method 100 typically includes, at 102, receiving a command from a user to display a user-selected tutorial 42a containing information related to a scientific procedure 44a, wherein the tutorial includes one or more requirements 50, 54 for performing the scientific procedure.

At 104, the method typically includes displaying the user-selected tutorial 42a. Typically the tutorial is displayed in a tutorial presentation area 46, as described above. At 106, the method typically includes selecting for display one or more products suitable to meet each requirement. Optionally, the method may include receiving a user profile including information on a current inventory of lab equipment and/or materials possessed by the user, and basing the selection of products for display on the user profile. The user profile may be lab specific and/or entity specific, and the selection of products may include selecting products compatible with the user's current lab or entity inventory, or selecting products not including those already within the user's current lab or entity inventory. An optimal product may also be selected based on the user's lab or entity profile.

At 108, the method typically includes, on the same interface as the tutorial, displaying product information corresponding to one or more commercially available products required to conduct the scientific procedure. Typically the product information is displayed on the same screen as the tutorial, however, alternatively it may be displayed via a pop up screen, etc. The method may also include providing a product purchase option selector to enable a user to purchase a desired product.

The above embodiments of the invention may be used to both educate a user about a scientific procedure, and to enable a user to procure products necessary to conduct the scientific procedure, thereby saving the user valuable time as compared to prior methods, which generally required consulting treatises or textbooks to determine how to conduct the procedure and separate, multiple catalog sources to order the materials and equipment.

While the invention has been particularly shown and described with reference to the foregoing preferred embodiments, those skilled in the art will understand that many variations may be made therein without departing from the spirit and scope of the invention as defined in the following claims. The description of the invention should be understood to include all novel and non-obvious combinations of elements described herein, and claims may be presented in this or a later application to any novel and non-obvious combination of these elements. Where the claims recite “a” or “a first” element or the equivalent thereof, such claims should be understood to include incorporation of one or more such elements, neither requiring nor excluding two or more such elements.

1. A computer-implemented education and procurement system for use in learning about scientific procedures and procuring products related thereto, the system comprising:
a graphical user interface (GUI) configured to display:
(a) a user-selected tutorial having a description of a scientific procedure;
(b) one or more requirements for the scientific procedure; and
(c) product information regarding one or more commercially available products that may be used to satisfy each requirement.

2. The system of claim 1, wherein the product information and the tutorial are linked, such that as a user interacts with a selected portion of the tutorial, the GUI is configured to display in response one or more products related to the selected portion.

3. The system of claim 1, wherein the product information includes a product icon visually depicting each product.

4. The system of claim 1, wherein the product information includes a textual description of each product.

5. The system of claim 1, wherein the GUI is further configured to enable a user to enter a profile including information relating to a current inventory of lab equipment and/or consumable materials possessed by the user.

6. The system of claim 5, wherein the profile is a lab profile containing information for a user's lab.

7. The system of claim 5, wherein the profile is an entity profile containing information for a plurality of labs within a user's entity.

8. The system of claim 5, wherein the GUI is configured to select products for display based on the user profile.

9. The system of claim 8, wherein the GUI is configured to select and display products that are compatible with a user's current inventory of lab equipment and/or consumable materials.

10. The system of claim 8, wherein the GUI is configured to select and display products that are not duplicated among a user's current lab equipment and/or consumable materials, as indicated in the user's profile.

11. The system of claim 8, wherein the GUI is configured to indicate whether a product is already possessed by the user, as determined from the user's profile.

12. The system of claim 11, wherein GUI is configured to indicate whether a 5 product is possessed by another lab within the user's entity.

13. The system of claim 11, wherein GUI is configured to indicate whether a product is possessed by the user's lab.

14. The system of claim 1, wherein the GUI further includes a purchase option selector, configured to enable a user to purchase each product.

15. The system of claim 14, wherein the purchase option selector links a user to a remote vendor site, in order to complete a purchase of the selected materials.

16. The system of claim 1, wherein the GUI is downloadable and displayable by a web browser.

17. The system of claim 16, wherein the product information is served to the user by a third party server.

18. The system of claim 1, wherein the scientific procedure includes an experiment protocol.

19. The system of claim 1, wherein the scientific procedure is in a field selected from the group consisting of molecular biology, microbiology, cell biology, immunology, hematology, histology, genetics, and chemistry.

20. The system of claim 1, wherein the tutorial is configured to display a plurality of steps of the scientific procedure.

21. The system of claim 20, wherein the GUI is configured to display one or more step-specific requirements corresponding to each step.

22. The system of claim 21, wherein the GUI is configured to display one or more product options that will satisfy each step-specific requirement.

23. The system of claim 1, wherein the requirements include general requirements, needed throughout the entirety of the scientific procedure.

24. The system of claim 1, wherein the requirements are selected from the group consisting of lab equipment requirements and consumable material requirements.

25. A system for learning about a scientific procedure and procuring products related thereto, the system comprising:
education and procurement program software configured to cause a computing device to display a graphical user interface (GUI), the GUI including:
(a) a tutorial selector configured to enable a user to select a tutorial for viewing, the tutorial having a plurality of slides, at least one slide including a description of a scientific procedure;
(b) a tutorial presentation area configured to display the slides of the user-selected tutorial;
(c) a table of contents selector configured to enable a user to select a particular slide of the tutorial for display in the tutorial presentation area; and
(d) a product presentation area configured to display information on one or more products related to the scientific procedure;
wherein the education and procurement program software is configured to select products for display in the presentation area based on a user profile.

26. The system of claim 25, wherein the user profile contains information on an inventory of equipment and/or consumable materials possessed by a user.

27. The system of claim 26, wherein the education and procurement program software is configured to cause the GUI to display products compatible with the user's inventory of equipment and/or consumable materials.

28. The system of claim 26, wherein the education and procurement program software is configured to cause the GUI to display a recommended optimal product based on the user profile.

29. The system of claim 26, wherein the education and procurement program software is configured to cause the GUI to indicate whether any displayed products are already owned by the user, according to the user profile.

30. The system of claim 26, wherein the user profile is lab-specific.

31. The system of claim 26, wherein the user profile is entity-specific, and includes a information for a plurality of labs within the user's entity.

32. The system of claim 25, wherein the GUI includes a selector configured to enable the user to edit the user profile.

33. The system of claim 25, wherein the product presentation area includes a product selector configured to present one or more product icons for selection by the user.

34. The system of claim 33, wherein the product presentation area further includes a product description area configured to display a description corresponding to a product icon selected by the user.

35. The system of claim 33, further including a product purchase option selector configured to enable a user to purchase the selected product.

36. The system of claim 25, wherein the GUI further includes a transcript presentation area configured to display a transcript of narration corresponding to a current slide presented in the tutorial presentation area.

37. The system of claim 25, wherein the GUI further includes a tool selector, configured to enable a user to select a software tool selected from the group consisting of a help tool and a glossary tool.

38. A method for educating a user about a scientific procedure and products related thereto, the method comprising:
receiving a command from a user to display a user-selected tutorial containing information related to a scientific procedure;
displaying the user-selected tutorial; and
on the same interface as the tutorial, displaying product information corresponding to one or more commercially available products required to conduct the scientific procedure.

39. The method of claim 38, wherein the tutorial describes a plurality of steps of the scientific procedure, and the products are listed by procedure step.

40. The method of claim 38, wherein the scientific procedure includes one or more requirements, and the method further comprises selecting for display one or more products suitable to meet each requirement.

41. The method of claim 38, further comprising:
receiving a user profile including information on a current inventory of lab equipment and/or materials possessed by the user.

42. The method of claim 41, further comprising, selecting products for display based on the user profile.

43. The method of claim 42, wherein the products are selected to be compatible with lab equipment and/or materials currently possessed by the user, as indicated by the user profile.

44. The method of claim 41, further comprising, displaying an indication to the user of whether a product is currently possessed by the user, according to the user profile.

45. The method of claim 41, wherein the user profile is lab-specific.

46. The method of claim 41, wherein the user profile is entity-specific, and includes information for a plurality of labs within the user's entity.

47. A program storage medium readable by a computing device, the program storage medium tangibly embodying a program of instructions executable by the computing device to perform a method for use in educating a user about a scientific procedure and products related thereto, the method comprising:
receiving a command from a user to display a user-selected tutorial containing information related to a scientific procedure;
displaying the user-selected tutorial; and
on the same screen as the tutorial, displaying product information corresponding to one or more commercially available products required to conduct the scientific procedure.
